(19) United States
(12) Patent Application Publication
(10) Pub. No.: US 2022/0009714 A1
(43) Pub. Date: Jan. 13, 2022

(54) SYSTEM, DEVICE AND METHOD OF DISCHARGING FLEXIBLE CONTAINERS

(71) Applicant: Fuji Seal International, Inc., Osaka-shi (JP)

(72) Inventors: Jeroen Gerrit Anton Gebbink, Helmond (NL); Marinus Antonius Leonarda Van Heck, Haarsteeg (NL); Stijn Antonius Petrus Verhoeven, Beek En Donk (NL)

(73) Assignee: Fuji Seal International, Inc., Osaka-shi (JP)

(21) Appl. No.: 17/273,524

(22) PCT Filed: Sep. 6, 2019
(86) PCT No.: PCT/NL2019/050580

§ 371 Date: Mar. 4, 2021

(30) Foreign Application Priority Data
Sep. 7, 2018 (NL) 2021584

(51) Int. Cl. B65G 1/06; B65B 43/14; B65G 1/04

(52) U.S. Cl. CPC B65G 1/06; B65G 1/045; B65B 43/14

(57) ABSTRACT

The present disclosure relates to a discharge system for discharging a plurality of containers from a tubular storage assembly having a plurality of interconnected elongated guiding elements, wherein the interconnected elongated guiding elements are configured to be maintained in a tubular arrangement. The discharge system may have a tubular storage assembly support configured to support the tubular storage assembly, and a discharge device configured to receive the containers from the tubular storage assembly in the receiving portion and to move the removed containers from the receiving portion towards the discharge portion. The receiving portion of the discharge device includes a docking ring configured to engage the free ends of respective elongated guiding elements and to position the engaged elongated guiding elements into the predetermined target tubular arrangement.

The present disclosure relates to a discharge system for discharging a plurality of flexible containers from a tubular storage assembly.

Flexible containers for keeping fluid or dry products, such as a liquid, granular material, powder or the like, are known in the art. One example of a flexible container is a flexible pouch container comprising, for instance, a laminate composed of sheets of plastic or the like. For instance, a container may be made of a front and back wall comprising one or more flexible film, facing one another and joined, for example welded, along their edges. The container has a dispensing spout to provide access to the interior of the container and to allow any contents in the container to be dispensed therefrom.

A tubular storage assembly developed by the same applicant is disclosed in the international publication WO 2015/128427 A1. The tubular storage assembly comprises a plurality of interconnected elongated guiding elements onto which a plurality of rows of dispensing spouts and associated pouch containers can be carried. The interconnected elongated guiding elements are configured to be maintained in a substantially tubular arrangement while the containers extend in the interior formed by the tubular arrangement. In this manner the tubular storage assembly provides for a reliable and efficient means for storage and/or transport of large numbers of pouch containers.

The pouch containers in the tubular storage assembly usually are empty containers. This is because the pouch containers may be manufactured at a location different from the location at which the containers are further handled, for instance filled with contents, such as foodstuff. For instance, the containers may be manufactured at a first location, loaded into the guiding elements, packed, stored and then transported to a second location where they are stored again and then unpacked and unloaded for further handling.

Discharge systems and methods have been developed to unload the pouch containers from a tubular storage assembly. WO 2017/032470 A1 discloses a discharge system and method wherein the guiding elements of a tubular storage assembly are aligned with respect to a discharge device so that the pouch containers can be pushed out of the tubular storage device right into a discharge device wherein the containers are gripped by a gripper and moved to a discharge position. The known method and system may allow the pouch containers to be discharged in a relatively fast, reliable and/or efficient manner from their tubular storage assemblies.

It is an object of the present disclosure to provide a discharge system, discharge device and method of discharging that are just as good as or even improved relative to the known discharge systems as concerns speed, reliability and efficiency of discharging the pouch containers from the tubular storage device.

Furthermore, it has been found that for a reliable, fast and efficient manner of discharge of the spouted containers from the guiding elements of the tubular assembly it is important that the discharge ends of the guiding elements are accurately positioned relative to the (gripper of the) discharge device of the discharge system. A misalignment of the guiding free ends of the guiding elements with respect to the discharge device may lead to a reduced performance. A misalignment may occur, in practice, when the original shape of the tubular storage assembly has been changed, for instance caused by—but not limited to these causes—the deformation of the tubular storage assembly during the above-mentioned packing, storing, transporting, and unpacking phase. In case the tubular storage assembly has been deformed and the tubular storage assembly arrives at the discharge system in a deformed state or deformed condition, is has not always been practical to try to unload the pouch containers in a fully automatic manner. In other words, handling problems may arise when unloading the pouch containers after the transport phase. These handling problems may be addressed by one or more operators who may be able to manually bring the tubular storage assembly from the deformed arrangement to a predetermined target tubular arrangement, for instance the original tubular arrangement before the deformation took place. However, such operator intervention may have a detrimental effect on the discharge speed, reliability and/or efficiency, and also adds up to the handling costs of the discharge process.

Consequently, there is a need to provide a discharge system, discharge device and discharge method wherein discharging of pouch containers from the tubular storage assembly can be accomplished in a relatively fast, reliable and/or efficient manner, and, preferably, also in a fully automatic manner, even in case of tubular storage assemblies that have been deformed from their original tubular arrangement into a deformed tubular arrangement.

It is therefore also an object of the present disclosure to provide a discharge system, discharge device and discharge method wherein discharging of pouch containers from the tubular storage assembly also in case the guiding elements are in a deformed tubular arrangement.

According to a first aspect at least one of the objects may at least partially be achieved in a discharge system for discharging a plurality of flexible containers from a tubular storage assembly, wherein each of the containers comprises a dispensing spout and wherein the tubular storage assembly comprises a plurality of interconnected elongated guiding elements onto which a plurality of rows of dispensing spouts can be carried, wherein the interconnected elongated guiding elements are configured to be maintained in a substantially tubular arrangement while the containers extend in the interior formed by the tubular arrangement, the discharge system comprising:
a storage assembly support configured to support at least one tubular storage assembly, the at least one tubular storage assembly being in a first tubular arrangement relative to a second, predetermined target tubular arrangement;
a discharge device including a receiving portion and a discharge portion and configured to receive the containers from the tubular storage assembly in the receiving portion and to move the received containers from the receiving portion towards the discharge portion;

wherein the receiving portion of the discharge device comprises a docking ring configured to allow a supported tubular storage assembly to be docked onto the discharge device, wherein the docking ring is configured to engage the free ends of respective elongated guiding elements and positioning the engaged elongated guiding elements from the first tubular arrangement into the predetermined target tubular arrangement.

The docking ring may engage the guiding elements when the docking ring is moved towards the guiding elements or, preferably, when the elongated guiding elements are moved towards the docking ring. Furthermore, as used herein, the predetermined target arrangement may be the original tubular arrangement of the storage assembly, for instance the shape before the tubular storage assembly has been deformed as a result of transport movements. The predetermined target arrangement may also be another arrangement suitable for unloading the containers once the tubular storage assembly has been docked onto the discharge device.

The intended positions of the (free ends) of the elongated guiding elements in the desired target tubular arrangement may be defined as the target positions of the (ends of the) elongated guiding element. In embodiments of the present disclosure the docking ring comprises a plurality of teeth extending in axial direction, wherein the teeth are distributed along the docking ring at different circumferential positions corresponding to predetermined target positions of the respective elongated guiding elements in their second, predetermined target tubular arrangement.

In further embodiments the free ends of the teeth are arranged at positions to allow inserting the free ends into the ends of respective elongated guiding elements (for instance by moving the guiding elements over the teeth and/or by moving the teeth of the ring into the guiding elements during the docking process), thereby moving the ends of the guiding elements from the first tubular arrangement (which may a deformed arrangement) into the second, target tubular arrangement. During the relative movement of the docking ring and the elongated guiding element the tubular storage assembly is automatically moved into the desired (target) shape.

In embodiments of the present disclosure each tooth of the docking ring is positioned at a different circumferential position coinciding with a target position of the associated elongated guiding element, so that after the docking process each and every of the elongated guiding elements extends at its correctly aligned target position.

In certain embodiments the docking ring extends in a transversal direction, perpendicular to the axial direction. Furthermore, the docking ring may comprise teeth of at least two different heights (i.e. the distance in axial direction, herein also referred to as “length”) as to first engage one or more first elongated guiding elements and then one or more second elongated guiding elements. In this way the docking ring starts with only moving the first elongated guiding elements to the target position(s) and to start moving the second elongated guiding elements only after the start of the movement of the first elongated guiding elements towards their target position(s).

In an embodiment the docking ring may be attached to the discharge device or may form an integral part of the discharge device. This implies that the tubular storage device is docked (connected) to a docking ring that may already have been properly aligned with the discharge device. Alternatively, in another embodiment, the docking ring may be part of a separate docking ring unit configured to first allow the guiding elements to be docked to the docking ring and then the docking ring to be properly positioned relative to the discharge device, preferably connected to the same.

The docking ring may comprise a plurality of teeth extending in axial direction and facing the tubular storage assembly support when the elongated guiding elements are supported on the tubular storage assembly support. The teeth may be configured to engage the free ends of respective elongated guiding elements and guide the elongated guiding elements with respect to the receiving portion of the discharge device into a plurality of predefined positions when the elongated guiding elements are moved relative to the docking ring. In specific embodiments the docking ring comprises a plurality of tooth sets, each tooth set including one, two or more teeth, wherein each set of teeth is preferably configured to engage one associated guiding element.

The teeth of the docking ring enable the tubular storage assembly to be docked to the discharge device essentially without human intervention. Also in case the tubular storage assembly arrives at the site of the discharge system in a deformed state or deformed condition, the docking ring makes it possible to dock the tubular storage arrangement and also ensures that the storage assembly in the deformed arrangement is brought back into its original arrangement.

In an embodiment the docking ring comprises a first tooth set with at least one tooth of a first height for engaging a first guiding element and a second tooth set with at least one tooth of a second height, smaller than the first height, for engaging a second guiding element. When moving the tubular assembly towards the docking ring, the first guiding element will be engaged first, then the second guiding element (that is directly connected to the first guiding element) will be engaged and positioned, then the next guiding element (that is connected to the previous guiding element) will be engaged and positioned, etc. Therefore, in embodiments of the present disclosure, the docking ring may comprise one or more further tooth sets for engaging one or more consecutive further guiding elements, wherein tooth sets associated with the one or more consecutive further guiding elements have teeth of descending heights. Every further guiding element may be engaged by teeth of a smaller height than the previous guiding element. In some embodiments the heights descend monotonously, although in other embodiment this is not the case.

In other embodiments the docking ring comprises a first tooth set with at least one tooth of a first height for engaging a first guiding element, a pair of second tooth sets, each second tooth set having at least one tooth of a second height smaller than the first height, wherein the second tooth sets are arranged for engaging second guiding elements directly connected to the first guiding element. The docking ring may further comprise at least one pair of further tooth sets, each further set having at least one tooth of a further reduced height, wherein each of the further tooth sets is arranged for engaging further guiding elements directly connected to a previous guiding element.

The docking ring may be configured to first engage a first guiding element with a first tooth set and subsequently engage one or more further guiding elements with one or more further tooth sets, when the tubular storage assembly is moved towards the discharge device or the discharge device is moved towards the tubular storage assembly.

In order to ensure that at least one of the guiding elements of the tubular storage device is properly aligned with the discharge device before the tubular storage device is being engaged by the docking ring, the tubular storage assembly support, in a further embodiment, may comprise a positioning element configured to position at least one of the guiding elements of the supported tubular storage assembly at a fixed position relative to the discharge device. Preferably the tooth set with at least one tooth having the largest height is located in such a manner that it is able to engage the specific guiding element that is positioned by the positioning element of the storage assembly support.

In principle the actual movement of the tubular discharge assembly against the docking ring and/or the moving of the spouted pouch containers from the tubular discharge assembly can be done manually. However, in practice the discharge system may comprise a push device configured to engage at least one container at the opposite end of the tubular storage assembly and/or to engage the tubular storage assembly to push the tubular storage assembly in axial direction against the docking ring.

According to another aspect of the present disclosure a method of discharging a plurality of flexible containers from a tubular storage assembly using the present discharge system is provided, the method comprising:
arranging a tubular storage assembly on the tubular storage assembly support, the tubular storage assembly being in a first tubular arrangement relative to a second, predetermined second target tubular arrangement;
moving the docking ring moved towards the guiding elements and/or moving the elongated guiding elements towards the docking ring so as to dock the supported tubular storage assembly onto the discharge device, wherein the docking ring engages the free ends of respective elongated guiding elements and positions the engaged elongated guiding elements from the first tubular arrangement to the second, predetermined target tubular arrangement.

In case the docking ring comprises a plurality of teeth extending in axial direction and facing the storage assembly support when the elongated guiding elements are supported on the storage assembly support, the method may further comprises having the teeth engage the free ends of respective elongated guiding elements and guide the elongated guiding elements relative to the receiving portion of the discharge device into a plurality of predefined positions when the elongated guiding elements are moved relative to the docking ring.

The method may further comprise engaging at least one container at the opposite end of the tubular storage assembly and/or engaging the opposite end of the tubular storage assembly so as to push the tubular storage assembly in axial direction against the docking ring.

The method may further comprise engaging at least one container at the opposite end of the tubular storage assembly so as to move the containers into the receiving portion of the discharge device.

The method may also comprise gripping the dispensing spouts of containers moved into the discharge device and successively passing by the gripper unit, to transport the gripped dispensing spouts and associated containers in essentially the axial direction and to collect the dispensing spouts at the discharge portion.

When in the first tubular arrangement the tubular storage assembly may be in a deformed shape and when in the second, predetermined target arrangement the tubular storage assembly may be in a predetermined target shape. The discharge system and method then makes it possible to move the guiding elements so as to bring the tubular assembly from its deformed shape into the correct final shape (wherein the guiding elements are accurately aligned with the receiving portion of the discharge device). In some situations the tubular storage assembly in the first tubular arrangement may already be (almost or fully) in the correct shape so that the no movement or hardly any movement is needed to bring the tubular storage assembly into its second, predetermined final shape.

Further characteristics of the present invention will be elucidated in the accompanying description of various preferred embodiments thereof. In the description reference is made to the annexed figures.

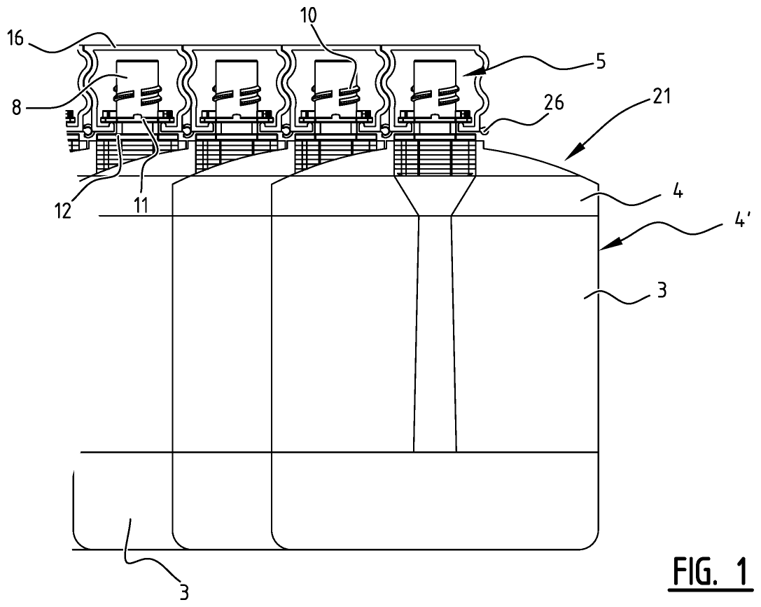

FIG. 1 is a schematic view of an exemplifying container used in an assembly according to an embodiment of the present invention;

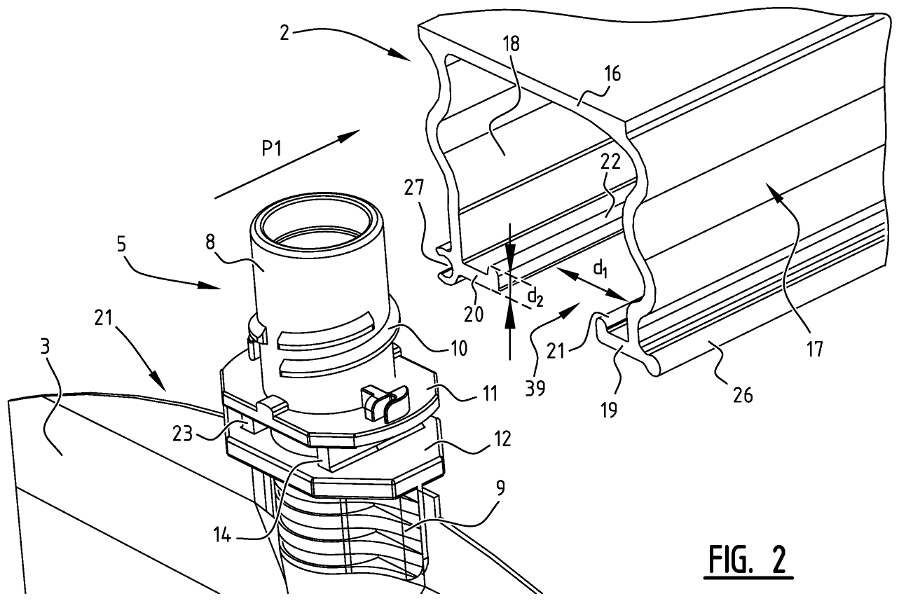

FIG. 2 is a combination of the container of FIG. 1 and an embodiment of a guiding element;

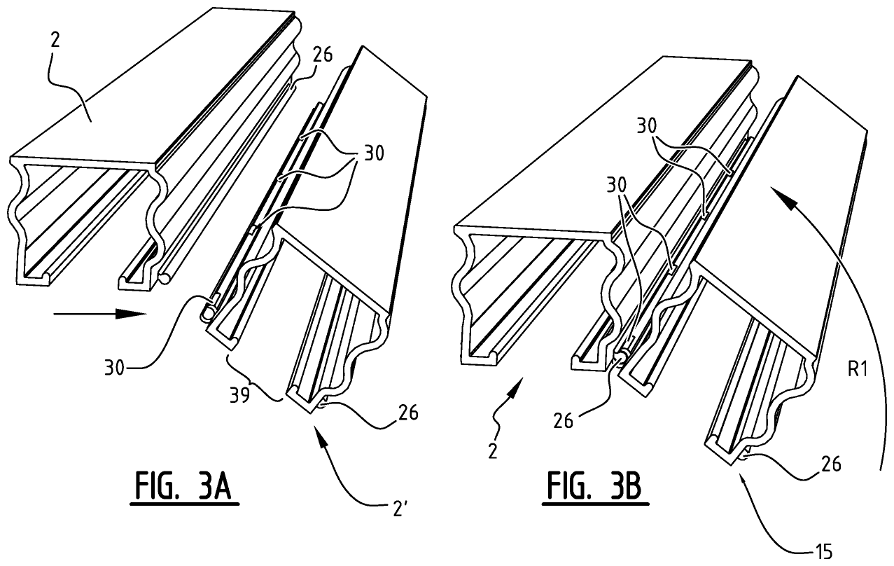

FIGS. 3A and 3B are perspective views of the guiding elements in disconnected and connected condition, respectively;

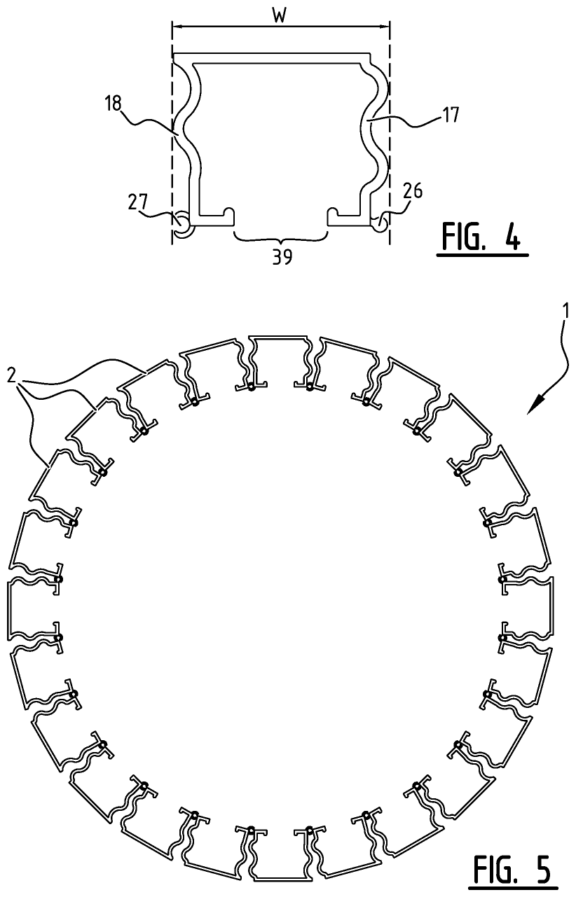

FIG. 4 is a schematic view of a cross-section of a guiding element, showing the maximum width of the guiding element and the distance between the coupling elements thereof;

FIG. 5 is a cross section of the tubular storage assembly comprising a number of the guiding elements of FIGS. 3 and 4;

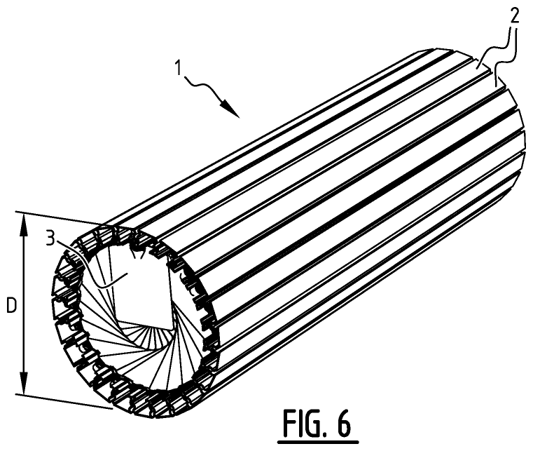

FIG. 6 is a side view of the tubular storage assembly in its predetermined target arrangement, loaded with a large number of spouted pouch containers;

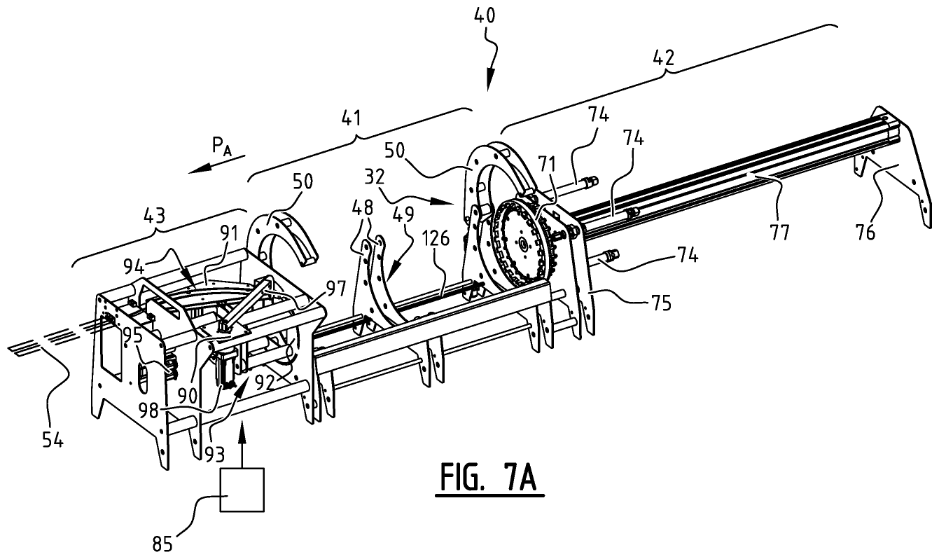

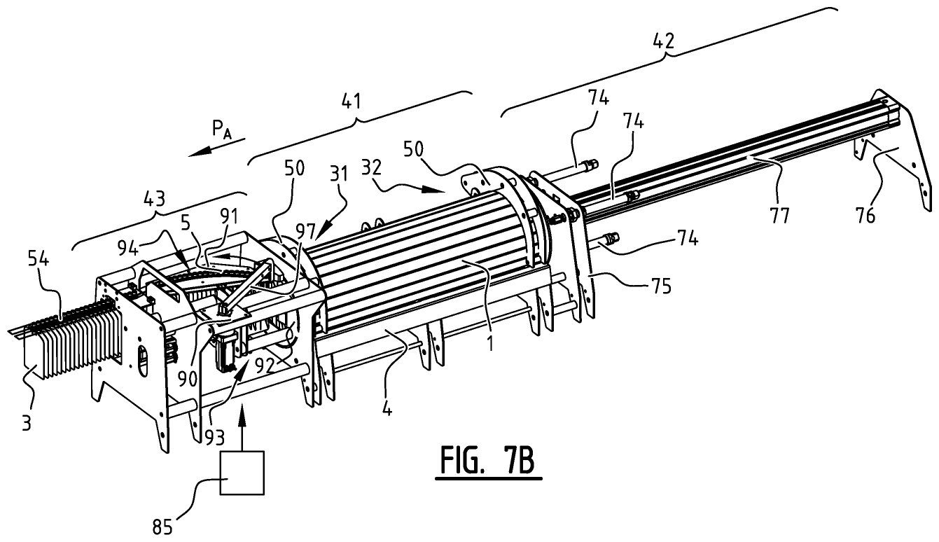

FIGS. 7A and 7B are side views of a first embodiment of a discharge system, in an opened and closed position respectively;

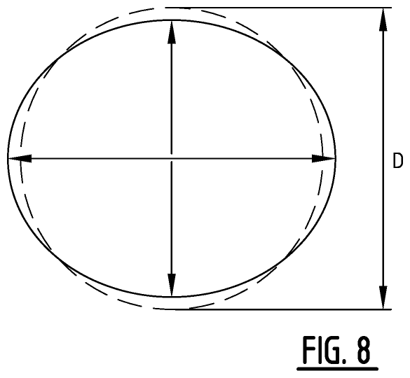

FIG. 8 is a schematic cross-section of a tubular storage assembly in a deformed arrangement;

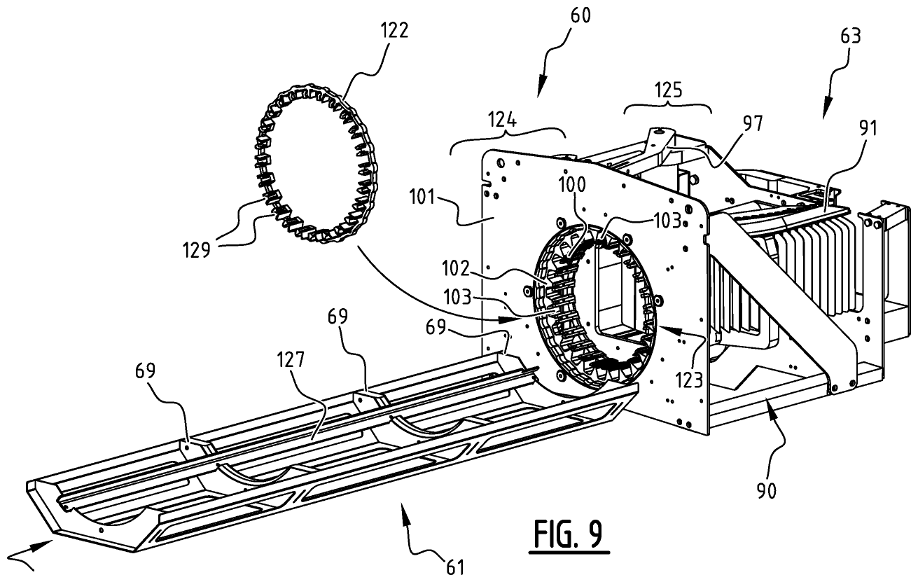

FIG. 9 is an exploded side view of a second embodiment of a discharge system including a storage assembly support and a discharge device;

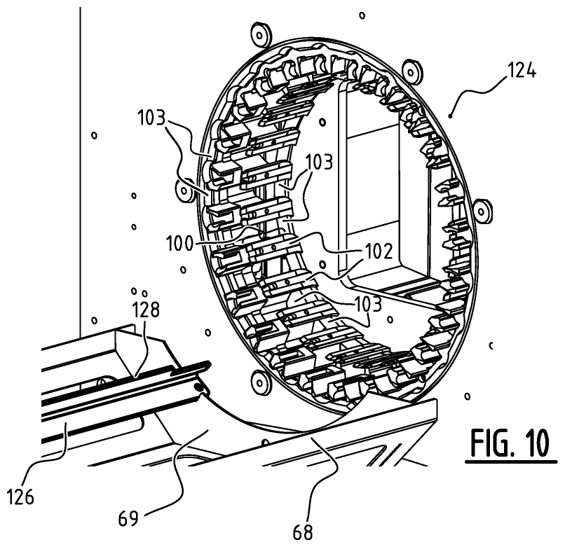

FIG. 10 is a side view of the second embodiment of a discharge system of FIG. 9, with the docking ring attached to the discharge device;

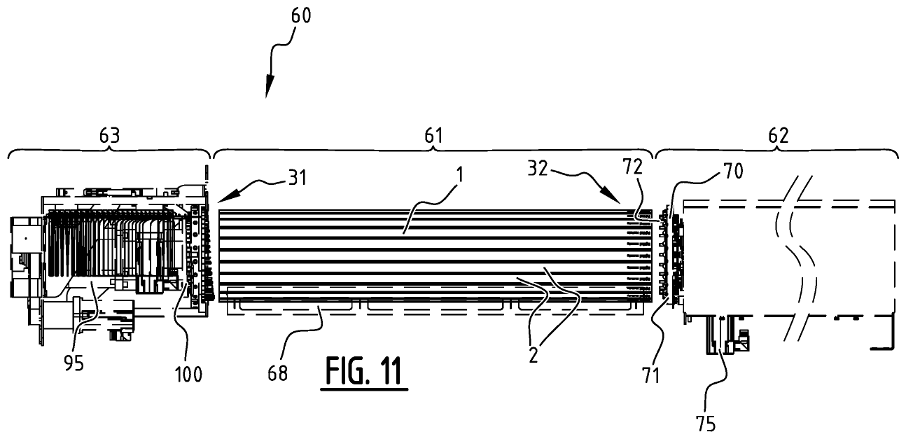

FIG. 11 is a side view of the second embodiment of FIGS. 9 and 10, including a push device;

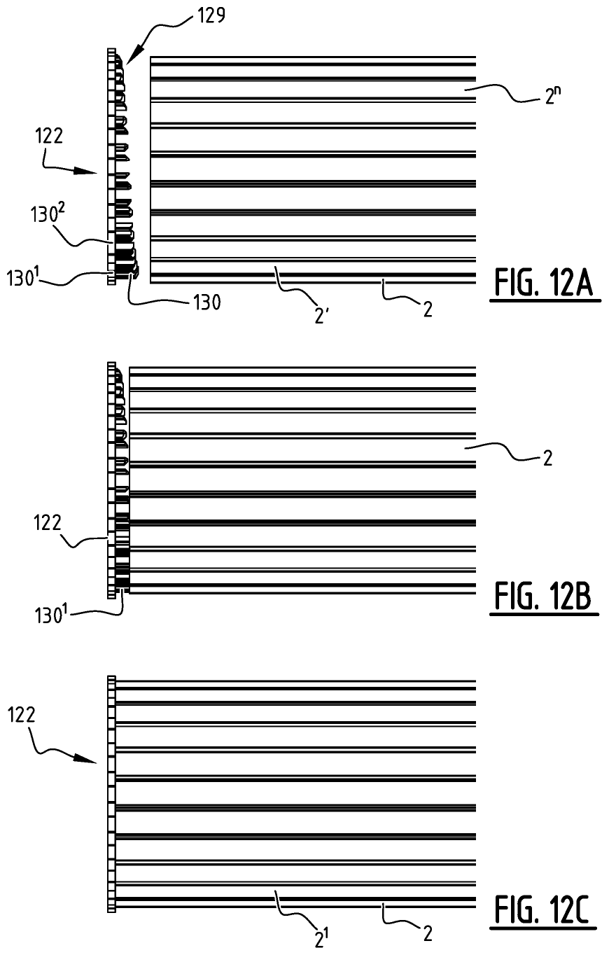

FIGS. 12A-12C are side views showing the insertion of the teeth of a docking ring into the guiding elements of a tubular storage assembly, before docking, in a halfway position and in a fully inserted position, respectively;

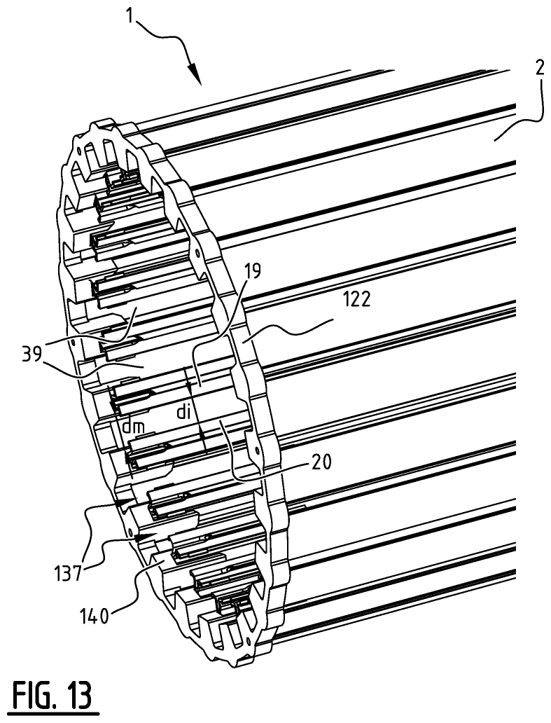

FIG. 13 is a cut-away side view of a tubular storage assembly on which a docking ring is mounted;

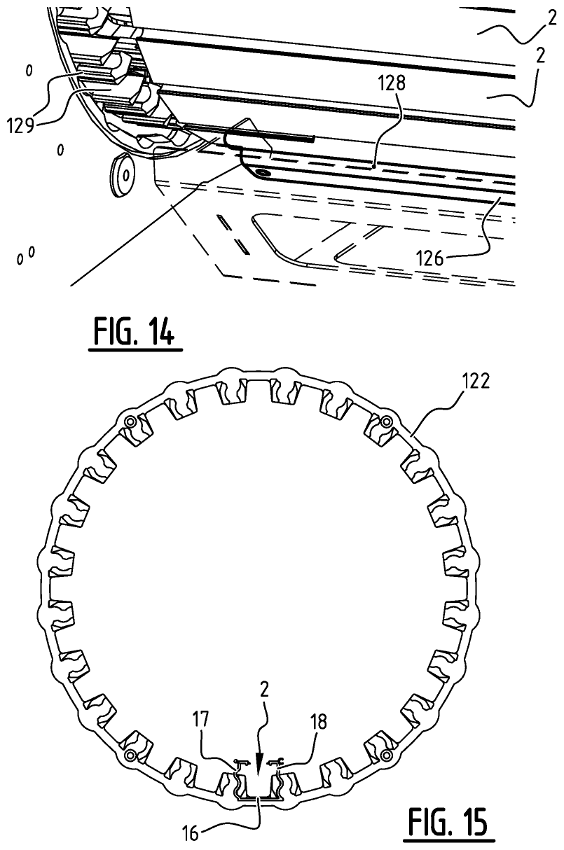

FIG. 14 is a detailed side view of a positioning element;

FIG. 15 is a schematic view in cross-section of a docking ring and one guiding element;

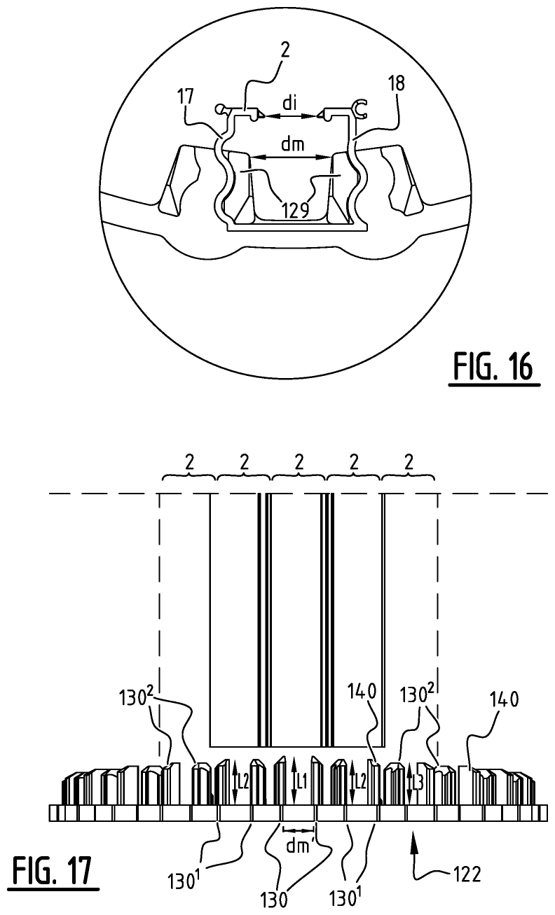

FIG. 16 is a detailed view of FIG. 15; and

FIG. 17 is a side view of an embodiment of the docking ring and a plurality of guiding elements, before docking.

In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily obscuring the present invention.

As will be apparent to those of skill in the art upon reading this disclosure, each of the individual embodiments described and illustrated herein has discrete components and features which may be readily separated from or combined with the features of any of the other several embodiments without departing from the scope of the present invention. Any recited method can be carried out in the order of events recited or in any other order which is logically possible.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

In the following description several embodiments of a discharge system are described. Each discharge system generally comprises a tubular storage assembly support configured to carry one or more tubular storage assemblies, a discharge device configured to discharge the pouch containers 3 from a discharge end of the tubular storage assembly 1 and, optionally, a push device configured to push the pouch containers towards the discharge device.

### Tubular Storage Assembly

As herein defined the tubular storage assembly 1 may be an assembly of elongated guiding elements 2 placed in such arrangement that they define the shape of a tube. Herein the tubular storage assembly may therefore also be denoted by the term “tubular arrangement”. The axial direction here is defined as the longitudinal direction of the tubular storage assembly 1 (i.e. a direction parallel to the longitudinal direction of the elongated guiding elements 2). Each of the guiding elements 2 of the tubular storage assembly 1 is configured to allow guiding of one or more pouch containers 3 so that the pouch containers 3 may be stored inside the interior formed by the combination of guiding elements 2. Several examples of a tubular storage assembly 1 are described hereafter that may be unloaded by a discharge system 40, for instance a discharge system as described in WO 2017/032470 A1, the content of which is herein incorporated by reference.

FIG. 1 shows a number of pouch containers 3 (herein also referred to as “pouches” or “containers”), comprising a front wall 4 and a back wall 4′, both walls 4, 4′ being made of thin, flexible film material, preferably plastic film material. The walls 4, 4′ are sealed along their circumferential edges to form a package for flowable products, for example foodstuff, cosmetics, medicines, etc. In the upper edge of the pouch container 3 a dispensing element, herein also referred to as a (dispensing) spout 5, is arranged.

Referring to FIG. 2, the spout 5 of the pouch container 3 comprises an elongated dispensing tube 8. The upper end of the dispensing tube 8 is provided with thread windings 10 for attaching a removable end cap (not shown) on the pouch container 3 after it has been filled. The lower end of the dispensing tube 8 extends through the upper circumferential edge and extends into the interior thereof so that the dispensing tube 8 may provide a fluid connection between the interior of the pouch container 3 and its surroundings so that the content of the pouch container 3 may be dispensed when the end cap is removed. The dispensing tube 8 is provided with two lateral elements which serve to attach the pouch container 3 to a guiding element 2. More specifically, the dispensing tube 8 comprises an upper flange part 11 and a lower flange part 12.

Guiding rail or guiding element 2 is an elongated section comprising an upper part 16, a first side wall 17 and a second side wall 18, both side parts extending roughly orthogonally with respect to the upper part 16. In the embodiment shown in the figures, for instance in FIG. 4, the side walls 17,18 have a cross-section that may be partially curved, for instance generally S-shaped. In other embodiments the side walls are straight side walls. At the free ends of the side walls 17, 18 a slotted carrier part for carrying the spout of a spouted pouch is provided. The carrier part comprises inwardly extending section flanges 19, 20 forming a slot or channel 39 between the free ends of the flanges 19, 20. The distance (d₁) between the section flange 19 of the first side wall 17 and section flange 20 of the second side wall 18 is slightly larger than the distance between upright walls 14,23 of the spout 5 and smaller than the width of the upper flange part 11 and lower flange part 12 of the spout 5. Furthermore the section flanges 19, 20 are provided at their respective outer ends with longitudinal ridges 21, 22 along which the upper flange part 11 of the dispensing element (spout 5) of the pouch container 3 can be slid. The distance between the upper flange part 11 and the lower flange part 12 of the spout 5 is slightly larger than the distance d₂ between the top and bottom of a longitudinal ridges 21,22 and such that the longitudinal ridges 21, 22 are properly maintained between the upper flange part 11 and lower flange part 12. Therefore the pouch container 3 can be moved easily into the guiding element 2 by sliding the spout 5 smoothly (in direction Pi) to be stably maintained within the guiding element 2 by the both flange parts 11, 12 of the spout 5 and the section flanges 19, 20 of the guiding element 2. The number of pouch containers 3 that can be arranged in the guiding element 2 depends amongst others on the length of the guiding element 2 and the dimensions of the respective spouts 5 of the pouch containers 3. As a not limiting example a typical guiding element may carry between 50 and 60 pouches.

Referring to FIGS. 2 and 3A-B the first side wall 17 of the guiding element 2 is also provided with an outwardly extending flange forming a male coupling element 26. Similarly the second side wall 18 of the guiding element 2 comprises a female coupling element 27. The male and female coupling elements 26, 27 extend along at least a substantial part of the length of the guiding element 2 and are dimensioned in such a way that the male coupling element 26 of a first guiding element 2 can be inserted into the female coupling element 27 of a second guiding element 2′ to mutually connect the first and second guiding elements 2, 2′. The coupling elements 26, 27 are configured to connect two or more parallel guiding elements 2, 2′, while still allowing the guiding elements 2,2′ to be moved relative to one another. To this end the female coupling element 27 may have one or more pivot elements 30 enabling the guiding elements 2, 2′ to be pivoted in a smooth and stable manner (R₁, FIG. 3B). Since connected guiding elements 2 may still be pivoted relative to each other, they can be positioned in different arrangements. For instance, the guiding elements 2 may be positioned or folded into the above mentioned tubular arrangement 1 when guiding elements are connected to other guiding elements.

When the guiding elements 2 are pivoted into the tubular arrangement 1, the last two guiding elements 2 may be connected to each other as well, as is indicated in FIG. 5. The guiding elements 2 arranged in the tubular arrangement 1 of FIG. 5 are self-maintaining (or self-supporting) so that the guiding elements 2 can be coupled in such a manner, that they are mutually supported and that they more or less remain in a tubular arrangement 1. In certain embodiments the guiding elements 2 are covered by a sleeve (for instance, a wrap made of stretchable foil material) or a tube in order to maintain the guiding elements 2 in their tubular arrangement 1 during transport. After transport, for instance in a stage wherein the pouch containers 3 are to be unloaded from the guiding elements 2, the sleeve or tube may be removed. In this situation the tubular arrangement 1 may be deformed relative to its original arrangement, which may give rise to handling problems when unloading the pouch containers 3 after the transport phase.

Referring to FIG. 6 a tubular storage assembly 1 is shown comprising a plurality of guiding elements 2 (i.e. guiding elements that have been interconnected as described above or, in other embodiments, guiding elements that remain unconnected and are held in the tubular arrangement by external means such as a cover or tube arranged around the guiding elements). The guiding elements 2 have been loaded with a large number of pouch containers 3. The figure shows that the spouted pouch containers 3 have been inserted into the tube-like arrangement in such a manner that they extend in a generally helical trajectory along the length of the guiding elements 2. In other words, in order to optimize the use of the space available in the interior of the tubular storage assembly 1, the containers 3 may be arranged in the tubular arrangement 1 in angularly displaced positions.

The number of guiding elements 2 of the tubular arrangement 1 may vary. Generally the number of guiding elements is n, wherein n=1, 2, 3, 4 . . . . Furthermore, not all guiding elements 2 need to be filled with containers 3. In embodiments of the invention only a subset of the guiding elements 2 is selectively filled, for instance six or twelve of a total number of 24 guiding elements 2, depending on the shape and/or size of the containers 3, for instance with a view to provide for a compact storage.

In a typical (but non-limiting) example 24 containers per rotation (revolution) can be accommodated in the tubular arrangement 1. Depending on the length of the guiding elements 2 and the dimensions of the containers 3 about 53 rotations can be accommodated in the tubular arrangement 1. This means that the storage capacity of one tubular storage assembly 1 can be as high as 1272 containers.

As mentioned earlier, it is important for a reliable and fast discharge of the guiding elements 2 from the tubular storage assembly 1 that the discharge ends of the guiding elements 2 are accurately positioned relative to the discharge device. However, since the individual guiding elements 2 may be slightly movable relative to each other and/or deformable in case the guiding elements 2 have been made of flexible material, an accurate positioning of the guiding elements 2 with respect to the discharge device is still difficult to achieve. For instance, due to the nature of the cover used to protect the tubular arrangement 1 during transport (for instance a stretch wrap (foil) arranged around the tubular assembly 1) and/or as a result of external impact or transport movements during the transport phase, the guiding elements 2 may sometimes arrive at the discharge system 40 in a state wherein the guiding elements 2 have been displaced relative to each other and no longer extend in exactly in their original arrangement, for instance the tubular arrangement 1 as shown in FIG. 5 or 6.

For instance, referring to FIGS. 6 and 8, the tubular arrangement 1 can be deformed (i.e. the guiding elements 2 may be displaced relative to each other, for instance their mutual distances may be changed and/or they become twisted in their axial/longitudinal direction, for instance during the transport phase) in such a manner that its shape in cross-section is no longer circular (with original diameter D, see FIG. 6), but rather oval (cf. FIG. 8). For instance, at the moment a tubular storage assembly 1 is loaded into a discharge system 40,60 (cf. FIGS. 7A,7B,9-11), the guiding elements 2 of the tubular storage assembly 1 may no longer extend parallel to each other, but may have been twisted somewhat so that the guiding elements 2 of the tubular storage assembly 1 are not aligned with the discharge device. This deformation may be detrimental to a reliable docking of the tubular storage assembly 1 on the discharge device and a reliable discharge of the pouch containers 3 from the loaded tubular storage assembly 1 once it has been docked.

One option would be to manually attach an additional ring to the discharge end 31 of the tubular storage assembly 1 before placing the tubular storage assembly 1 in the support 41. The additional ring may have a first side configured to allow an accurate fit into the docking flange of the discharge device 43,63 and a second, opposite side that may be attached to the free ends of the guiding elements 2 of the tubular assembly 1 so as to urge the free ends to retake their original mutual positions so that (at least the discharge end 31 of) the tubular storage assembly 1 regains its original shape. Due to the presence of the docking ring the guiding elements 2 of the tubular storage assembly 1 on the support 41 may extend in line with the receiving guiding elements 102 of the discharge device 63 so that the spouts 5 of the pouch containers 3 may be reliably slid from the tubular storage assembly 1 into the discharge device 43, 63. However, an operator is needed to position and attach the ring to the deformed (for instance displaced) guiding elements 2 which is a quite burdensome task and takes a considerable amount of time. Furthermore, even if the additional ring has been attached to the tubular storage assembly 1 and the tubular storage assembly 1 has been placed in the support 41,61, the guiding elements 2 of the tubular storage assembly 1 and the additional ring still need to be aligned manually by the operator with the receiving further guiding elements 2 in the discharge device 43,63 before the tubular storage assembly 1 can be docked on the discharge device 43, 63.

In order to correctly position the guiding elements 2 relative to the discharge device 43, 63 a docking ring may be connected to the discharge device 43, 63 or may be an integral part of the discharge device 43, 63, as will be explained later.

### Discharge System—Storage Assembly Support

Referring to FIGS. 7A and 7B a discharge system 40 may be provided in order for the pouch containers 3 to be unloaded from the tubular storage assembly 1 in a fast and reliable manner. The discharge system 40 generally comprises a tubular storage assembly support 41 configured to carry one or more tubular storage assemblies 1, a discharge device 43 configured to discharge the pouch containers 3 from a discharge end of the tubular storage assembly 1 and, optionally, a push device 42 configured to push the pouch containers 3 towards the discharge device 43. In the following an example of such pouch container discharge system 40 is described. Examples of pouch container discharge systems have also been described in WO 2017/032470 A1 and EP 3 225 573 A1, both documents being herein incorporated by reference. Several features of these exemplifying pouch container discharge systems are discussed hereafter.

FIGS. 7A and 7B show an embodiment of the (pouch container) discharge system 40 for discharging a plurality of flexible pouch containers 3 that have been arranged in the tubular storage assembly 1. FIG. 7A shows the discharge system 40 without the tubular storage assembly 1, i.e. before the discharge system 40 is loaded with a tubular storage assembly 1. As mentioned earlier, the discharge system 40 comprises a tubular storage assembly support 41, a discharge device 43 and, optionally, a push device 42. FIG. 7B shows the same discharge system 40 in the situation wherein a loaded tubular storage assembly 1 is placed on and supported by the tubular storage assembly support 41.

The tubular storage assembly support 41 of the discharge system 40 comprises a stationary support frame 48 having curved sections 49 on which a tubular storage assembly 1 can be placed. The tubular storage assembly support 41 also comprises two movable clamping arms 50. The clamping arms 50 are curved as well (for instance, semi-circular) and can be pivoted between an open position as shown in FIG. 7A and a closed position as shown in FIG. 7B. In the closed position the movable clamping arms 50 together with the curved sections 49 of the stationary support frame 48 form a clamp for firmly holding and supporting the tubular storage assembly 1. More specifically, in the open position of the clamping arms 50, the arms 50 provide space for the tubular storage assembly 1 to be placed upon the support frame 48. Once the tubular storage assembly 1 has been arranged on the support frame 48, the clamping arms 50 can be pivoted towards the closed position. In the closed position the positioning arms 5, together with the stationary support frame 48, form an essentially annular construction enclosing an essentially cylindrical space. The curved clamping arms 50 and the curved parts of the support frame 48 may cooperate to force the tubular storage assembly 1 into a more or less cylindrical shape.

The above tubular storage assembly support 41 is used to fixedly clamp a tubular storage assembly that comprises more or less flexible guiding elements, for instance guiding elements made material that can be bent or that tends to sag under the influence of gravity. In situation wherein the guiding elements are made of more stiff material, a tubular storage assembly support 63 may be used wherein the guiding elements are supported only and no further clamping action takes place, as will be explained hereafter.

FIGS. 9-11 show another embodiment of a discharge system 60 according to the present disclosure. Similar to the discharge system 40 of FIGS. 7A and 7B, the discharge system 60 of FIG. 9 comprises a tubular storage assembly support 61, a discharge device 63 and, optionally, a push device 62 (not shown). The tubular storage assembly support 61 comprises a support frame 68 including a number of curved carrier elements 69 for carrying a couple of the lowermost guiding elements 2 of the tubular storage assembly 1 (not shown in the figure). Unlike the discharge system 40 the support 61 of the discharge system 60 does not have any movable clamping arms to clamp the tubular storage assembly 1 onto the support frame 68. The tubular storage assembly 1 is solely kept in place by the curved shape of the carrier elements 69.

Discharge System—Push Device

In FIGS. 7A, 7B an embodiment is shown wherein close to a pushed end 32 of the tubular storage assembly 1 a push device 42 of the discharge system 40 is arranged. FIG. 11 shows that also discharge system 60 may comprise a (similar) push device 62. The push device 42,62 may comprise a first unit for pushing against the pushed end 32 of the tubular assembly 1 to urge the tubular storage assembly 1 including the pouch containers 3 as a whole in axial direction against the discharge device 63 and/or a second unit for pushing only against one or more of the pouch containers 3 positioned at the pushed end 32 of the tubular storage assembly 1 in order to urge the containers 3 towards the discharge end 31 of the tubular storage assembly 1 (thereby also indirectly applying an axial force on the tubular storage assembly 1).

For instance, the push device 42,62 may comprise a stationary frame 75,76 for carrying a pusher element 70 having a number of radial pins 72 configured to engage one or more pouch containers 3 arranged at the pushed end 32 of the tubular storage assembly 1. The pusher element 70 may be pushed in axial direction by a linear actuator 77, thereby pushing the pouch containers 3 arranged in the tubular storage assembly 1 along the guiding elements 2 in axial direction towards the opposite end thereof (i.e. towards the discharge end 31). By moving the pouch containers 3 in axial direction (cf. direction P_{A} in FIG. 7B) towards the distal, discharge end 31, the containers 3 located at the discharge end 31 may be taken out of the tubular storage assembly 1 and fed through the discharge device 43,63 to an output device (for instance, a linear conveyor or outfeed lane 54).

Alternatively or additionally, the push device 42, 62 may be configured to engage the pushed end 32 of the tubular storage assembly 1, for instance the end faces of the guiding elements 2, by a support or push ring 71. The push ring 71 may be pushed in axial direction by a couple of linear actuators 74. The ring 71 is sized to engage the ends of the guiding elements 2.

Further details about the push device may be derived from WO 2017/032470 A1, the content of which is herein incorporated.

In embodiments of the present disclosure therefore the push device may axially position the discharge end 31 of the tubular storage assembly 1 relative to the discharge device 43,63 or, more specifically, to move the tubular storage assembly 1 onto a docking ring 122 of the discharge device 43,63, as will be explained later.

Discharge System—Discharge Device Referring to FIGS. 7A, 7B, 9 the discharge device 43,63 is positioned at the discharge end 31 of the tubular storage assembly 1 (when placed on the support 41, 61, respectively). The discharge device 43,63 is configured to receive through its receiving portion 124 the pouch containers 3 that have been displaced in axial direction by the push device 42,62 from the tubular storage assembly 1 and to move the pouch containers 3 one by one towards a discharge portion 125 of the discharge device 42,62 in a discharge area of the discharge system 40,60 where the pouch containers 3 are collected for further transport. The discharge device 43,63 can be connected or associated with any output device, for instance an outfeed lane 54, for further transport of the pouch containers 3, for instance in the direction of one or more handling stations. In the figures outfeed lane 54 has been schematically shown in dotted lines in order to make clear that in fact any type of output device can be used to discharge the pouch containers 3 from the discharge area of the discharge device 43,63.

An example of a suitable discharge is described in WO 2017/032470 A1, the content of which is included here. Similar examples are shown in FIGS. 7A,7B and FIGS. 9-11. FIGS. 7A and 7B show a stationary frame 90 in which a rotor or rotatable gripper unit 93 comprising a rotatable gripper support 92 and a slotted gripper 91 is mounted. The rotatable gripper support 92 can be driven by a drive, for instance an electric motor 95 connected to the stationary frame 90. As described in WO 2017/032470 A1, the rotatable slotted gripper 91 is configured to grip (during rotation thereof relative to the stationary tubular storage assembly 1) one by one the spouts 5 of consecutive pouch containers 3 and carry them in the slot 94 provided therein. Once a sufficient number of pouch containers 3 has been gripped and collected in the slot 94 of the slotted gripper 91, a control unit 85 controls the electric motor 95 to interrupt the rotation of the slotted gripper 91 and then controls the electric motor 98 of a rotatable sweeper arm 97 (that is rotatably mounted to the stationary frame 90) to move the collected pouch containers 3 towards the outfeed lane 54.

Optionally, a stationary intermediate tubular unit 100 can be mounted to the frame 90 and arranged at the receiving portion 124 of the discharge device 43,63, between the opening in the front plate 101 facing the tubular storage assembly 1 and the position wherein the rotatable slotted gripper 91 consecutively grips the pouch containers 3. The intermediate tubular unit 100 comprises a number of elongated parallel receiving further guided elements 102. The further guiding elements 102 define between them a number of channels 103 corresponding to the earlier mentioned channels 39 provided in the guiding elements 2 (cf. FIG. 2). The receiving further guiding elements 102 are to be exactly aligned with the guiding elements 2 of the tubular storage assembly 1 once the assembly 1 has been placed on the support 41,61 so that they form one combined, elongated channel (combination of channels 39 and 103).

In order to receive the pouch containers 3 in a reliable manner the channels 39 in the guiding elements 2 should be accurately aligned with the receiving portion 124 of the discharge device 43,63, more specifically with the rotatable gripper unit 93 and/or with the channels 103 in the stationary intermediate tubular unit 100. To this end the receiving portion 124 of the discharge device 43,63 may comprise a docking flange 123 onto which a docking ring 122 can be mounted. This docking ring 122 can be a ring that is removably attachable to the receiving portion 124 of the discharge device 43, 63 (as is the case in the embodiment of FIGS. 9 and 10, wherein FIG. 9 shows the docking ring 122 in detached position and FIG. 10 the same docking ring 122 in attached position) or may be an integral part of the discharge device 43, 63. The docking ring 122 is configured to allow a supported deformed tubular storage assembly 1 to be properly docked onto the discharge device 43,63. To this end the docking ring 122 is configured to engage the free ends of respective elongated guiding elements 2 (as they are moved in the direction of the docking ring 122 in the docking process to connect the tubular storage assembly 1 to the discharge device 43, 63) and to position the engaged elongated guiding elements 2 into a the correct, predetermined target tubular arrangement 1. When the tubular storage assembly 1 supported on the tubular storage assembly support 41, 61 initially is in a first tubular arrangement wherein the tubular storage assembly 1 is in a slightly deformed but still generally tubular shape, the guiding elements 2 can be displaced relative to each other so that they are positioned into a different second tubular arrangement wherein the deformation has been reduced or removed altogether and the guiding elements 2 are better aligned with the receiving portion 124 of the discharge device 43, 63. When initially the tubular storage assembly 1 already is in the second, target tubular arrangement (for instance since the tubular storage assembly 1 already is sufficiently tubular), the discharge device 43, 63 will assure that the guiding elements 2 will be kept in this second, target arrangement during the unloading process of the flexible containers 3.

More specifically, once the guiding elements 2 of the deformed tubular storage assembly 1 have been docked to the docking ring 122 and their free ends are urged to their correct positions in the target tubular arrangement, the channels 39 in the respective guiding elements 2 are properly aligned with the channels 103 in the discharge device 43, 63 and hence a correct and reliable transfer of the spouts 5 of the pouch containers 3 from the tubular storage assembly 1 to the discharge device 43, 63 can be accomplished.

Positioning of Tubular Storage Assembly

In embodiments of the present disclosure the tubular assembly 1 may be loaded on the support 41,61, docked onto the discharge device 43,63 and unloaded by the discharge device 43,63 in a fast and reliable manner, essentially without needing any manual intervention so that the cost of labor and thereby the cost of operation of the discharge system 40,60 may be reduced.

First of all, the support frame 48, 68 of the support 41,61 of the discharge system 40,60 may comprise a positioning element 126 configured to position one of the supported guiding elements 2 at a fixed position relative to the discharge device 43,63. This is to ensure that at least one of the guiding elements 2 is positioned correctly relative to the discharge device 43, 63, i.e. relative to the teeth 129 of the docking ring 122. In the embodiment of FIG. 9, the positioning element 126 is embodied as an elongated positioning rails 127 attached to at least one of the curved carrier elements 69 and extending in axial direction. The positioning rails 127 may include an elongated positioning flange 128 oriented radially inward and extending in axial direction as well and shaped so as to be inserted between the side walls 17,18 of two neighboring guiding elements 2. In certain embodiments the interspaced between the side walls 17, 18 of the guiding elements 2 is relatively small so that the positioning flange 128 snugly fits between the guiding elements 2.

The positioning flange 128 of the support 41,61 may be positioned such that the free ends of the guiding elements 2 extending at either side of the guiding flange 128 are positioned at a suitable (predetermined and fixed) location relative to the docking flange 123 of the discharge device 43,63. Preferably, the positioning element 126 not only positions the free ends of the two guiding elements 2 correctly relative to the docking flange 123, also ensures that the guiding elements 2 come to lie more parallel to each other. In the shown embodiment the positioning flange 128 has an elongated shape parallel to the axial direction so that the two neighboring guiding elements 2 are forced to extend parallel relative to each other (and no longer extend in a twisted fashion or at least less so).

Furthermore, the discharge device 43,63 comprises a docking ring 122 that is configured to correctly move the outer ends of the elongated guiding elements 2 from their incorrect positions in the deformed arrangement to the correct positions in the predetermined target tubular arrangement. Referring to FIGS. 9,10, 12A-12C the docking ring 122 has a plurality of teeth 129. The teeth 129 are formed at the circumference of the docking ring 122, typically a positions corresponding the target. They generally extend in axial direction and face the storage assembly support 41,61 when the elongated guiding elements 2 are supported thereon. The teeth 129 are configured to engage the free ends of respective elongated guiding elements 2 and guide the elongated guiding elements 2 relative to the receiving portion 124 of the discharge device 43,63 into a plurality of predefined target positions when the elongated guiding elements 2 are moved relative to the docking ring 122, for instance when the push device 42, 62 pushes the tubular storage assembly 1 towards the docking ring 122. The predefined target positions may be the respective correct positions of the guiding elements 2 corresponding to the predetermined target arrangement, preferably the original positions of the guiding elements 2 before deformation during transport.

In embodiments of the present disclosure the docking ring 122 comprises a plurality of tooth sets 130, 130¹, 130², . . . , 130ⁿ, with n the total number of tooth sets. The total number (n) of tooth sets generally corresponds to the number of guiding elements 2 in the tubular storage assembly 1. Each tooth set 130, 130¹, 130², . . . , 130ⁿ may including one, two, or more teeth 129. In the embodiments shown in the figures each tooth set has two teeth 129, i.e. a first tooth 129 configured to engage and guide the first side wall 17 of a guiding element 2 and a second tooth 129 configured to engage and guide a second side wall 18 of the same guiding element 2. The first and second tooth are further positioned at a mutual distance (dₘ, see FIG. 17) corresponding to or slightly wider than the width (d₁) of a channel 39 in the guiding element 2 (the channel 39 being defined as the slot between the free ends of the flanges extending inwardly from the side walls of the elongated guiding element 2 and carrying the spouts 5 of the spouted containers 3) so that the spouts 5 can easily and in an unobstructed manner be transferred from the guiding element 2 via the space between the teeth 129 into the channels 103 in the discharge device 43, 63 (cf. FIG. 10).

Referring to FIGS. 15 and 16, the shape of the part of a tooth 129 facing a side wall 17,18 of a guiding element 2 may correspond to the shape of the side wall 17, 18. When, for instance, the side walls 17,18 have a curved shape, such as an S-shape, the teeth 129 may take a corresponding shape in order to provide for an improved guiding of the guiding element 2 onto the teeth 129.

Furthermore, referring to FIG. 17, free ends 140 of the teeth 129 may have a lead-in portion configured to lead the free ends of the elongated guiding elements as were smoothly towards their respective target positions. The fee ends 140 may have a generally chamfered shape so as to assist the movement of a tooth 129 into the associated guiding element 2 and/or to assist a smooth guiding of the elongated guiding element 2 into its associated correct position.

Referring to FIGS. 12A-12C and 17, in embodiments of the present disclosure, the docking ring 122 comprises a first tooth set 130 with at least one tooth 129 of a first height (h₁) (i.e. the length of the tooth 129 in axial direction) for engaging a first guiding element 2 and a second tooth set 130¹ with at least one tooth 129 of a second height (h₂), smaller than the first height (h₁), for engaging a second guiding element 2¹. When moving the tubular assembly 1 towards the docking ring 122 (FIG. 12A), the first guiding element 2 will be engaged first by the first tooth set 130. After the first guiding element 2 has been engaged, then (at least) the second guiding element 2′ (which is directly connected to the first guiding element 2) is engaged and positioned by the second tooth set 130¹ (FIG. 12B). Then the next guiding element (that is connected to the previous guiding element) will be engaged and positioned. This is repeated until all guiding elements 2 have been engaged and brought into the correct position (FIG. 12C).

In embodiments of the present disclosure the tooth sets associated with the series of consecutive further guiding elements 2 have teeth 129 of descending heights. In other words, the first tooth set 130 has a maximum height (h₁) and every further tooth set 130¹,130², . . . , 130ⁿ has a descending height. In these embodiments every further guiding element 2 is engaged by teeth 129 of a smaller height than the previous guiding element 2. In some embodiments the heights descend monotonously, although in other embodiment this is not the case. The number of different heights may correspond to the number of guiding elements 2 of the tubular storage assembly 1.

In other embodiments the heights of the tooth descend on either side of the first tooth set 130. For instance, the docking ring 122 may comprise a plurality of pairs of tooth sets, the teeth within each pair of tooth sets having the same height while the heights of consecutive pairs of tooth sets are ever more reduced. In an embodiment the docking ring 122 comprises a first tooth set with at least one tooth of a first height for engaging a first guiding element, a pair of second tooth sets, each second tooth set having at least one tooth 129 of a second height (h₂) smaller than the first height (h₁), wherein the second tooth sets are arranged for engaging second guiding elements directly connected to the first guiding element Furthermore, the docking ring 122 may comprise at least one pair of further tooth sets, each further set having at least one tooth of a further reduced height, wherein each of the further tooth sets is arranged for engaging further guiding elements directly connected to a previous guiding element.

Referring to FIG. 17, in an exemplifying embodiment of the present disclosure, the docking ring 122 comprises a first pair of second tooth sets 130¹ at either side of the first tooth set 130, both second tooth sets 130′ having the same height (h₂), smaller than the first height (h₁). The first pair of second tooth 130′ sets engage and position the two guiding elements 2¹ directly connected to the first guiding element 2. The docking ring 122 may also comprise a second pair of tooth sets 130² of a height h₃ smaller than the second height h₂ for engaging and positioning the two guiding elements 2² directly connected to the second guiding elements 2′. This may be repeated for all remaining guiding elements. In these embodiments the number of different heights may correspond to half the number of guiding elements 2 of the tubular storage assembly 1.

Referring to FIG. 14, in a particularly advantageous embodiment, the first tooth set (i.e. the tooth set including one or more teeth of the maximum height h₁) is located to engage the (first) guiding element 2 that is positioned by the earlier mentioned positioning element 126 of the storage assembly support 41, 61. Due to the positioning element 126 the position of this specific guiding element is fixed and known a priori, and the remaining guiding elements are positioned relative to this first guiding element. In an even more preferred embodiment the first tooth set having the largest height is positioned at the lowermost position.

It is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

1. A discharge system for discharging a plurality of flexible containers from a tubular storage assembly, wherein each of the containers comprises a dispensing spout and wherein the tubular storage assembly comprises a plurality of interconnected elongated guiding elements onto which a plurality of rows of dispensing spouts can be carried, wherein the interconnected elongated guiding elements are configured to be maintained in a substantially tubular arrangement while the containers extend in an interior space formed by the tubular arrangement, the discharge system comprising:
a tubular storage assembly support configured to support at least one tubular storage assembly, the at least one tubular storage assembly being in a first tubular arrangement relative to a second, predetermined target tubular arrangement; and
a discharge device including a receiving portion and a discharge portion and configured to receive the containers from the tubular storage assembly in the receiving portion and to move the received containers from the receiving portion towards the discharge portion;
wherein the receiving portion of the discharge device comprises a docking ring configured to allow the tubular storage assembly supported by the tubular storage assembly support to be docked onto the discharge device, wherein the docking ring is configured to engage free ends of respective elongated guiding elements and to position the engaged elongated guiding elements from the first tubular arrangement into the second, predetermined target tubular arrangement,
wherein the docking ring comprises a plurality of teeth extending in an axial direction, wherein the teeth are distributed along the docking ring at different circumferential positions corresponding to predetermined target positions of the respective elongated guiding elements in their second, predetermined target tubular arrangement.

2. (canceled)

3. The discharge system as claimed in claim 1, wherein free ends of the teeth are arranged at positions to allow inserting the free ends of the teeth into the ends of respective elongated guiding elements, thereby moving the ends of the elongated guiding elements from the first tubular arrangement into the second, target tubular arrangement and/or wherein each tooth of the docking ring is positioned at a different circumferential position coinciding with a target position of the associated elongated guiding element.

4. The discharge system as claimed in claim 1, wherein the docking ring extends in a transversal direction, perpendicular to an axial direction of the docking ring, and/or wherein the docking ring comprises teeth of at least two different heights so as to first engage one or more first elongated guiding elements and then one or more second elongated guiding elements.

5. The discharge system as claimed in claim 1, wherein the docking ring is attached to the receiving portion of the discharge device or is an integral part of the receiving portion of the discharge device.

6. The discharge system as claimed in claim 1, wherein the plurality of teeth of the docking ring face the tubular storage assembly when the elongated guiding elements of the tubular storage assembly are supported on the tubular storage assembly support, the teeth being configured to engage the free ends of respective elongated guiding elements and guide the elongated guiding elements relative to the receiving portion of the discharge device into a plurality of predefined positions when the elongated guiding elements are moved relative to the docking ring.

7. The discharge system as claimed in claim 1, wherein the docking ring comprises a plurality of tooth sets, each tooth set including one, two or more teeth, wherein each set of teeth is preferably configured to engage one associated guiding element.

8. The discharge system as claimed in claim 7, comprising a first tooth set with at least one tooth of a first height for engaging a first guiding element and a second tooth set with at least one tooth of a second height, smaller than the first height, for engaging a second guiding element.

9. The discharge system as claimed in claim 8, comprising one or more further tooth sets for engaging one or more consecutive further guiding elements, wherein tooth sets associated with the one or more consecutive further guiding elements have teeth of descending heights.

10. The discharge system as claimed in claim 7, comprising one or more members selected from the group consisting of: a first tooth set with at least one tooth of a first height for engaging a first guiding element; a pair of second tooth sets, each second tooth set having at least one tooth of a second height (h7) smaller than the first height (hᵢ), wherein the second tooth sets are arranged for engaging second guiding elements directly connected to the first guiding element; and at least one pair of further tooth sets, each further tooth set having at least one tooth of a further reduced height, wherein each of the further tooth sets is arranged for engaging further guiding elements directly connected to a previous guiding element.

11. (canceled)

12. The discharge system as claimed in claim 1, wherein the docking ring is configured to first engage a first guiding element with a first tooth set and subsequently engage one or more further guiding elements with one or more further tooth sets, when the tubular storage assembly is moved towards the discharge device or the discharge device is moved towards the tubular storage assembly.

13. The discharge system as claimed in claim 1, wherein the tubular storage assembly support further comprises a member selected from the group consisting of: a positioning element configured to position at least one of the guiding elements of the supported tubular storage assembly at a fixed position relative to the discharge device; and a positioning element configured to position at least one of the guiding elements of the supported tubular storage assembly at a fixed position relative to the discharge device wherein the positioning element of the tubular storage assembly support comprises elongated rails including a positioning flange oriented radially inward, the positioning flange being configured to be inserted between two neighboring guiding elements of a tubular storage assembly when placed on the storage assembly support.

14. (canceled)

15. The discharge system as claimed in claim 8, wherein the tooth set with at least one tooth having a largest height is located to engage a guiding element that is positioned by the positioning element of the tubular storage assembly support and/or,
wherein the tooth set having a largest height is positioned at a lowermost position.

16. (canceled)

17. The discharge system as claimed in claim 7, wherein a tooth set comprises a member selected from the group consisting of: a first and a second tooth arranged so as to engage respective opposite side walls of the elongated guiding element; a first and a second tooth further positioned at a mutual distance corresponding to or wider than a width of a channel in the elongated guiding element; and a tooth with a shape of a part of the tooth facing a side wall of the associated guiding element corresponding to a shape of the side wall, wherein the shape of the part is curved or S-shaped.

18. (canceled)

19. (canceled)

20. The discharge system as claimed in claim 1, wherein the free ends of the teeth have a lead-portion, preferably a lead-in portion of a generally chamfered shape, so as to assist a movement of a teeth into the associated guiding element and/or to guide the elongated guiding element into its associated target position.

21. The discharge system as claimed in claim 1, wherein the receiving portion of the discharge device comprises a plurality of channels extending in an axial direction, wherein the docking ring is configured to position the guiding elements such that each of the channels in the discharge device is aligned with a corresponding channel in each of the guiding elements.

22. The discharge system as claimed in claim 1, further comprising a member selected from the group consisting of: a push device configured to engage at least one container at an opposite end of the tubular storage assembly and/or to engage the tubular storage assembly to push the tubular storage assembly in an axial direction against the docking ring; and a push device configured to engage at least one container at an opposite end of the tubular storage assembly and/or to engage the tubular storage assembly to push the tubular storage assembly in an axial direction against the docking ring, wherein the pushing device is further configured to move the containers into the receiving portion of the discharge device.

23. (canceled)

24. The discharge system as claimed in claim 1, wherein the discharge device further comprises:
a gripper unit; and
a drive configured to cause the tubular storage assembly support and the gripper unit to rotate relative to each other;
wherein the gripper unit is configured to grip dispensing spouts of containers moved into the discharge device and successively passing by the gripper unit, to transport the gripped dispensing spouts and associated containers in essentially an axial direction and to collect the dispensing spouts at the discharge portion.

25. A discharge device of a discharge system as claimed in claim 1.

26. (canceled)

27. A method of discharging a plurality of flexible containers from a tubular storage assembly using a discharge system as claimed in claim 1, the method comprising:
arranging the tubular storage assembly on the tubular storage assembly support, the tubular storage assembly being in the first tubular arrangement relative to the second, predetermined second target tubular arrangement;
moving the docking ring moved towards the guiding elements and/or moving the elongated guiding elements towards the docking ring so as to dock the supported tubular storage assembly onto the discharge device, wherein the docking ring engages the free ends of respective elongated guiding elements and positions the engaged elongated guiding elements from the first tubular arrangement to the second, predetermined target tubular arrangement.

28. The method as claimed in claim 27, wherein if the docking ring comprises a plurality of teeth extending in an axial direction and facing the storage assembly support when the elongated guiding elements are supported on the tubular storage assembly support, the method comprises a method selected from the methods consisting of:
having the teeth engage the free ends of respective elongated guiding elements and guide the elongated guiding elements relative to the receiving portion of the discharge device into a plurality of predefined positions when the elongated guiding elements are moved relative to the docking ring;
having the teeth engage the free ends of respective elongated guiding elements and guide the elongated guiding elements relative to the receiving portion of the discharge device into a plurality of predefined positions when the elongated guiding elements are moved relative to the docking ring and engaging at least one container at an opposite end of the tubular storage assembly and/or engaging the opposite end of the tubular storage assembly so as to push the tubular storage assembly in an axial direction against the docking ring;
having the teeth engage the free ends of respective elongated guiding elements and guide the elongated guiding elements relative to the receiving portion of the discharge device into a plurality of predefined positions when the elongated guiding elements are moved relative to the docking ring and engaging at least one container at an opposite end of the tubular storage assembly and/or engaging the opposite end of the tubular storage assembly so as to push the tubular storage assembly in an axial direction against the docking ring and engaging at least one container at the opposite end of the tubular storage assembly so as to move the containers into the receiving portion of the discharge device; and
having the teeth engage the free ends of respective elongated guiding elements and guide the elongated guiding elements relative to the receiving portion of the discharge device into a plurality of predefined positions when the elongated guiding elements are moved relative to the docking ring and engaging at least one container at an opposite end of the tubular storage assembly and/or engaging the opposite end of the tubular storage assembly so as to push the tubular storage assembly in an axial direction against the docking ring and engaging at least one container at the opposite end of the tubular storage assembly so as to move the containers into the receiving portion of the discharge device and gripping the dispensing spouts of containers moved into the discharge device and successively passing by the gripper unit, to transport the gripped dispensing spouts and associated containers in essentially an axial direction and to collect the dispensing spouts at the discharge portion.

29. (canceled)

30. (canceled)

31. (canceled)

32. (canceled)
